(19) United States
(12) Patent Application Publication
(10) Pub. No.: US 2026/0244234 A1
(43) Pub. Date: Aug. 20, 2026

(54) COMPACT DUAL LOOP LINEAR REGULATOR

(71) Applicant: STMicroelectronics International N.V., Geneva (CH)

(72) Inventors: Dorotea Battaglia, Milano (IT); Stefano Castorina, Milano (IT)

(21) Appl. No.: 19/055,262

(22) Filed: Feb. 17, 2025

(51) Int. Cl. G05F 1/575

(52) U.S. Cl. CPC G05F 1/575

(57) ABSTRACT

According to an embodiment, a low drop-out (LDO) regulator includes an error amplifier, multiple control loops, and a control circuit. The error amplifier compares a feedback voltage with a reference voltage to generate an error signal. A first control loop includes a first transistor coupled between a first supply voltage and an output voltage. A second control loop includes second and third transistors coupled in series between a second supply voltage and the output voltage. Switches selectively couple the error signal to the gates of the first or third transistor. The control circuit activates the first or second control loop based on supply voltage availability.

### TECHNICAL FIELD

The present disclosure generally relates to power systems and, in particular embodiments, to low drop-out (LDO) regulators featuring a dual control loop architecture for efficiently switching between multiple power supplies while minimizing the area overhead of the supply switching circuitry.

### BACKGROUND

In modern electronic systems, voltage regulators provide stable and reliable power to various components. These regulators are designed to maintain a constant output voltage despite input or load current fluctuations. Low drop-out (LDO) regulators have gained popularity among the different types of voltage regulators due to their simplicity, low noise, and fast transient response.

In the automotive industry, numerous electronic devices rely on LDO regulators to provide stable and regulated power to their internal circuits. However, when an LDO regulator is directly coupled to the battery, it may suffer reduced efficiency. This is because the battery voltage is typically higher than the desired output voltage of the LDO regulator, resulting in power dissipation across the regulator.

A common solution to address this efficiency issue is introducing a switching converter between the battery and the LDO regulator. The switching converter steps down the battery voltage to a level closer to the desired output voltage of the LDO regulator. By reducing the voltage drop across the LDO regulator, the overall power efficiency of the system is improved. The switching converter's output serves as the LDO regulator's power supply, providing a more efficient power source than directly coupling the LDO regulator to the battery.

However, introducing a switching converter presents a new challenge for the LDO regulator. The LDO regulator must be capable of seamlessly switching its power supply from the battery to the output of the switching converter as soon as the converter becomes available. This power supply switching capability ensures uninterrupted operation of the connected circuits and optimizes power efficiency.

The LDO regulator is configured to detect the presence of the switching converter's output and smoothly transition its power supply from the battery to the converter's output without causing any significant disturbances or glitches in the regulated output voltage. However, the switching circuitry can introduce additional complexity and occupy valuable circuit area, which can be a concern in space-constrained applications.

Moreover, the switching process can introduce voltage disturbances or glitches in the output of the LDO regulator if not correctly managed. These disturbances can adversely affect the performance of the connected loads, particularly sensitive analog or digital circuits.

Traditionally, LDO regulators employ a single control loop to regulate the output voltage. The control loop consists of an error amplifier that compares a fraction of the output voltage with a reference voltage and adjusts the conductance of a pass transistor to maintain a constant output voltage. However, when multiple power supplies are involved, the single control loop architecture may not be sufficient to handle the supply switching process effectively.

### SUMMARY

Technical advantages are generally achieved by embodiments of this disclosure, which describe low drop-out (LDO) regulators featuring a dual control loop architecture for efficiently switching between multiple power supplies while minimizing the area overhead of the supply switching circuitry.

A first aspect relates to a low drop-out (LDO) regulator, comprising an error amplifier configured to compare a feedback voltage with a reference voltage and generate an error signal; a first control loop comprising a first transistor coupled between a first supply voltage and an output node of the LDO regulator; a second control loop comprising a second transistor and a third transistor coupled in series between a second supply voltage and the output node of the LDO regulator; a first switch coupled between an output of the error amplifier and a gate of the first transistor; a second switch coupled between the output of the error amplifier and a gate of the third transistor; and a control circuit configured to control the first switch and the second switch to selectively activate the first control loop or the second control loop based on the availability of the first supply voltage and the second supply voltage.

A second aspect relates to a method for regulating an output voltage of a low drop-out (LDO) regulator, the method comprising comparing a feedback voltage with a reference voltage to generate an error signal; selectively activating a first control loop or a second control loop based on the availability of a first supply voltage and a second supply voltage, wherein the first control loop comprises a first transistor coupled between the first supply voltage and the output node of the LDO regulator, and the second control loop comprises a second transistor and a third transistor coupled in series between the second supply voltage and the output node of the LDO regulator; controlling the first transistor using the error signal when the first control loop is active; and controlling the third transistor using the error signal when the second control loop is active.

A third aspect relates to a low drop-out (LDO) regulator, comprising an error amplifier configured to compare a feedback voltage with a reference voltage and generate an error signal; a first transistor coupled between a first supply voltage and an output node of the LDO regulator; a second transistor coupled between the first transistor and the output node of the LDO regulator; a third transistor coupled between a second supply voltage and the output node of the LDO regulator; a fourth transistor coupled between the third transistor and the output node of the LDO regulator; a first switch coupled between an output of the error amplifier and a gate of the second transistor; a second switch coupled between the output of the error amplifier and a gate of the fourth transistor; and a control circuit configured to control gate terminals of the first transistor and the third transistor, and control the first switch and the second switch to selectively activate a first control loop comprising the first transistor and the second transistor or a second control loop comprising the third transistor and the fourth transistor based on the availability of the first supply voltage and the second supply voltage.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a schematic of a regulator circuit, which can be used to change the supply in an LDO regulator;

FIG. 2 is a schematic of a regulator circuit, which can be used to change the supply in an LDO regulator;

FIG. 3 is a schematic of a regulator circuit, which can be used to change the supply in an LDO regulator;

FIG. 4 is a flowchart of an embodiment method for operating an LDO regulator; and

FIG. 5 is a flowchart of an embodiment method for operating an LDO regulator.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of low drop-out (LDO) regulators, it should also be appreciated that these inventive aspects may also apply to other types of voltage regulators and power management circuits. In particular, aspects of this disclosure may similarly apply to linear regulators, switching regulators, and hybrid regulators that combine both linear and switching techniques. The concepts related to dual control loops and efficient supply switching can be adapted to improve the performance and area efficiency of various voltage regulation architectures beyond LDOs.

In embodiments, a low drop-out (LDO) regulator architecture incorporating a dual control loop design is proposed for efficient power supply switching. The LDO regulator aims to provide a stable and regulated output voltage while seamlessly switching between multiple power supplies, such as a primary battery supply and a secondary supply from a voltage converter. The architecture seeks to minimize the area overhead of the switching circuitry and reduce voltage disturbances during the switching process.

In one embodiment, the LDO regulator includes an error amplifier, a feedback network, and a transistor. The error amplifier compares a fraction of the output voltage with a reference voltage and generates an error signal. The transistor, controlled by the error signal, regulates the current flow from the selected power supply to the load, thereby maintaining a constant output voltage.

In embodiments, the proposed LDO regulator incorporates a dual control loop architecture, which enables efficient power supply switching. The dual control loops include a primary and secondary loop, each associated with a different power supply. The primary loop is active when the primary power supply is selected, while the secondary loop is active when the secondary power supply is selected. The control loops ensure a smooth transition between the power supplies without introducing significant voltage disturbances at the output.

To minimize the area overhead of the switching circuitry, the LDO regulator can employ a compact switching mechanism. The switching mechanism utilizes a set of switches and control signals to selectively connect the appropriate power supply to the input of the LDO regulator. The switches minimize losses and ensure fast switching transitions.

In embodiments, the control circuitry of the LDO regulator generates the control signals to manage the switching process. It can monitor the availability and characteristics of the power supplies and determine the optimal switching sequence. The control circuitry may incorporate additional features, such as hysteresis and debounce mechanisms, to prevent unwanted oscillations and ensure stable operation.

The dual control loop architecture of the LDO regulator offers several advantages. It allows for seamless power supply switching without compromising the stability and transient response of the regulator. The architecture also enables the optimization of the control loops for each power supply, considering their specific characteristics and requirements.

Embodiments of the disclosure may include various circuit-level implementations of the LDO regulator architecture. The specific circuit designs can be adapted to meet the requirements of different applications, such as low noise, high efficiency, or fast transient response. The LDO regulator may also incorporate additional features, such as overcurrent protection, thermal shutdown, and soft-start functionality, to enhance its robustness and reliability.

The LDO regulator architecture described in the present disclosure can find applications in various electronic systems where efficient power supply switching is desired. It can be particularly suitable for battery-powered devices, automotive systems, and industrial equipment, where multiple power supplies are present, and seamless switching between them is advantageous for optimal performance and power efficiency. These and additional details are further discussed below.

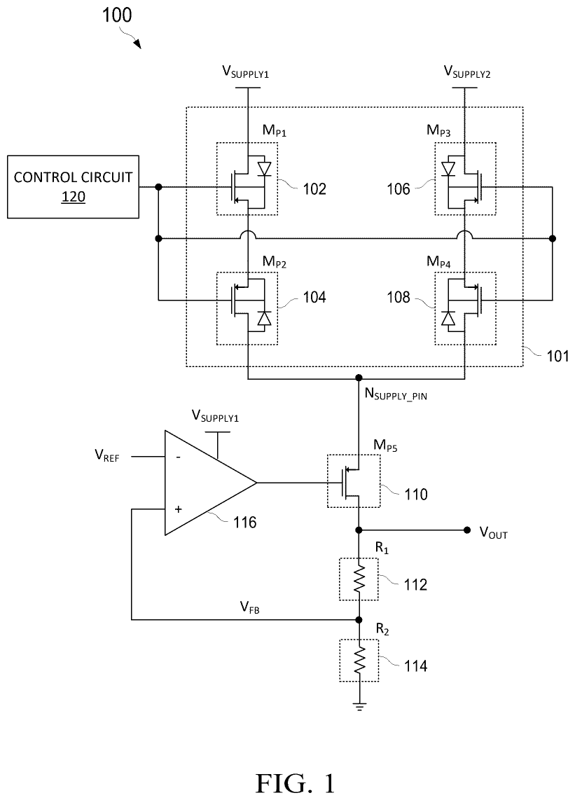

FIG. 1 illustrates a schematic of a regulator circuit 100, which can be used to change the supply in an LDO regulator. In an LDO regulator, switching the power supply from the battery (V_{SUPPLY1}) to the output of a switching converter (V_{SUPPLY2}) while maintaining a constant output voltage is advantageous. The battery (V_{SUPPLY1}) is the primary power source during the start-up phase or in the event of a fault. This ensures the LDO regulator can provide a stable output voltage even when the switching converter (V_{SUPPLY2}) is not operational. However, during regular operation, the LDO regulator relies on the internal voltage (V_{SUPPLY2}), typically provided by the output of a buck converter, to achieve higher power efficiency.

Regulator circuit 100 includes a first p-channel transistor (M_{P1}) 102, a second p-channel transistor (M_{P2}) 104, a third p-channel transistor (M_{P3}) 106, a fourth p-channel transistor (M_{P4}) 108, a fifth p-channel transistor (M_{P5}) 110, a first resistor (R₁) 112, a second resistor (R₂) 114, an error amplifier 116, and a control circuit 120, which may be arranged as shown. The gate terminals of the first p-channel transistor (M_{P1}) 102, the second p-channel transistor (M_{P2}) 104, the third p-channel transistor (M_{P3}) 106, and the fourth p-channel transistor (M_{P4}) 108 are coupled to the control circuit 120, which controls the switching between the supplies. Regulator circuit 100 may include additional components not shown.

A dedicated circuit 101 facilitates the seamless transition between the battery's output (V_{SUPPLY1}) and the switching converter (V_{SUPPLY2}). The dedicated circuit 101 enables the LDO regulator to switch its power supply from one source to another without causing disruptions or instability in the regulated output voltage (V_{OUT}). The switching circuit prevents cross-conduction, which can occur when both power supplies are simultaneously connected to the LDO regulator. Cross-conduction can lead to undesired current flow and potential damage to the system.

The first p-channel transistor (M_{P1}) 102 and the second p-channel transistor (M_{P2}) 104 form a back-to-back switch and are coupled in series between a first supply voltage (V_{SUPPLY1}), such as a battery, and an output voltage (V_{OUT}) of the regulator circuit 100. Similarly, the third p-channel transistor (M_{P3}) 106 and the fourth p-channel transistor (M_{P4}) 108 form another back-to-back switch and are coupled in series between a second supply voltage (V_{SUPPLY2}), such as the output of a switching converter, and the output voltage (V_{OUT}).

Further, the switching circuit ensures that the transition between power supplies does not introduce any significant voltage drops at the output of the LDO regulator. Voltage drops during switching can cause temporary dips or glitches in the regulated output voltage, adversely affecting the connected circuits' performance. The switching circuit minimizes these voltage drops and maintains a stable output voltage throughout the switching transition.

The control circuit 120 is responsible for generating the control signals for the first p-channel transistor (M_{P1}) 102, the second p-channel transistor (M_{P2}) 104, the third p-channel transistor (M_{P3}) 106, and the fourth p-channel transistor (M_{P4}) 108. The control circuit 120 monitors the availability and characteristics of the power supplies and determines the appropriate switching sequence. It ensures that the LDO regulator seamlessly switches between the power supplies without causing disruptions or instability in the regulated output voltage (V_{OUT}).

The output voltage (V_{OUT}) is provided at the shared node between the fifth p-channel transistor (M_{P5}) 110 and the voltage divider formed by the first resistor (R₁) 112 and the second resistor (R₂) 114. The voltage divider provides a feedback voltage (V_{FB}) to the non-inverting input of the error amplifier 116. The inverting input of the error amplifier 116 receives a reference voltage (V_{REF}).

The error amplifier 116 compares the feedback voltage (V_{FB}) with the reference voltage (V_{REF}) and generates an error signal. The error signal is provided to the gate of the fifth p-channel transistor (M_{P5}) 110 to control its conductivity and regulate the output voltage (V_{OUT}).

In embodiments, the value of the first supply voltage (V_{SUPPLY1}) is typically at 14 volts. In an embodiment, the minimum value of the first supply voltage (V_{SUPPLY1}) is 5.5 volts. In an embodiment, the value of the second supply voltage (V_{SUPPLY2}) is typically at 6 volts. In embodiments, the value of the reference voltage (V_{REF}) is 1.2 volts. In embodiments, the value of the output voltage (V_{OUT}) is 5 volts.

However, using this type of back-to-back switch arrangement has drawbacks. The back-to-back switches between the supply voltages (V_{SUPPLY1} and V_{SUPPLY2}) and the regulator supply node (N_{SUPPLY_PIN}) must carry the same current and have a very low voltage drop. LDOs are designed to operate mainly with supply voltages very close to the output voltage. Therefore, it is imperative to ensure that the sum of the drain-to-source voltage (V_{DS}) (drop-out) across the back-to-back switches and the fifth p-channel transistor (M_{P5}) 110 is small.

The drop-out voltage is the voltage difference between the input and output at which the LDO can no longer regulate against further decreases in the input voltage. In the dropout region, the transistors behave like resistors. The dropout voltage (V_{DROPOUT}) can be expressed in terms of the drain-source on-resistance (RDS_{ON}) and load current (I_{LOAD}): V_{DROPOUT}=I_{LOAD}×RDS_{ON}.

To obtain a small drain-source on-resistance (RDS_{ON}) (i.e., small V_{DS}), it is necessary to increase the area of the transistors. Adding switches in series means multiplying the area by a multiplying factor (e.g., 15) compared to a regulator with a single supply voltage. This increased area is a significant drawback of the known solution presented in regulator circuit 100.

For example, if the area of each transistor in the regulator circuit 100 is

$$\frac{3 \times W}{L} ,$$

where W represents the width and L represents the length of the transistor-assuming that the LDO regulator with a single supply voltage has a single transistor with an area of W/L. This regulator configuration's dropout voltage (V_{DROPOUT}) is equal to the dropout voltage of the LDO regulator with the single supply voltage. However, due to multiple transistors in series in regulator circuit 100, the overall area of regulator circuit 100 is approximately 15 times larger than the regulator with a single supply voltage.

The LDO regulator architecture presented in FIG. 1 provides a baseline solution for power supply switching using back-to-back switches. While this approach enables the LDO regulator to switch between the power supplies, it comes with the trade-off of increased area overhead. The back-to-back switches and the fifth p-channel transistor (M_{P5}) 110 contribute to a larger overall area compared to a single-supply LDO regulator. However, this architecture ensures a stable output voltage (V_{OUT}) during power supply switching and prevents cross-conduction between the power supplies.

Embodiments of this disclosure aim to address the problem of the increased area caused by the addition of the back-to-back switches in the regulator circuit 100. The objective is to find a way to reduce the number of transistors used in the switching circuit, thereby occupying less area on the integrated circuit.

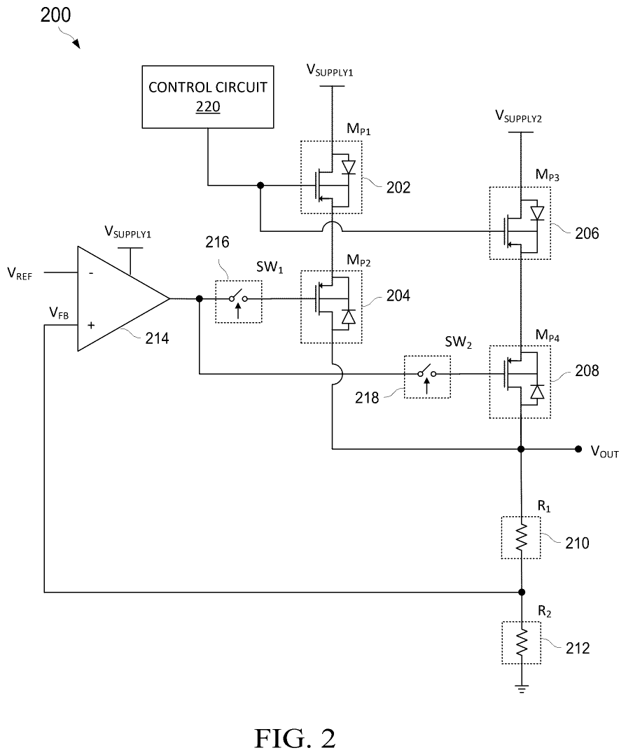

FIG. 2 illustrates a schematic of a regulator circuit 200, which can be used to change the supply in an LDO regulator. Regulator circuit 200 includes a first p-channel transistor (M_{P1}) 202, a second p-channel transistor (M_{P2}) 204, a third p-channel transistor (M_{P3}) 206, a fourth p-channel transistor (M_{P4}) 208, a first resistor (R₁) 210, a second resistor (R₂) 212, an error amplifier 214, a first switch (SW₁) 216, a second switch (SW₂) 218, and a control circuit 220, which may be arranged as shown. The gate terminals of the first p-channel transistor (M_{P1}) 202 and the third p-channel transistor (M_{P3}) 206 are coupled to the control circuit 220, which controls the switching between the supplies. Regulator circuit 200 may include additional components not shown.

The proposed solution in regulator circuit 200 aims to overcome the problem of the increased area due to adding the back-to-back switches in regulator circuit 100 through a reduction in the number of transistors. Here, the fifth p-channel transistor (M_{P5}) 110 from the regulator circuit 100 is eliminated. Instead, the second p-channel transistor (M_{P2}) 204 and the fourth p-channel transistor (M_{P4}) 208 are used as control transistors, each acting similarly to the fifth p-channel transistor (M_{P5}) 110 in the regulator circuit 100.

The control circuit 220 generates the control signals for the first p-channel transistor (M_{P1}) 202 and the third p-channel transistor (M_{P3}) 206, as well as the control signals for the first switch (SW₁) 216 and the second switch (SW₂) 218. The control circuit 220 monitors the availability and characteristics of the power supplies and determines the optimal switching sequence. It ensures that the appropriate control loop is activated based on the selected power supply. The control circuit 220 may incorporate additional features, such as hysteresis and debounce mechanisms, to prevent unwanted oscillations and ensure stable operation during power supply switching.

The error amplifier 214 is coupled to the gates of the second p-channel transistor (M_{P2}) 204 and the fourth p-channel transistor (M_{P4}) 208. The output of the error amplifier 214 controls the conductivity of these transistors to regulate the output voltage (V_{OUT}). Two control loops are provided through the first switch (SW₁) 216 and the second switch (SW₂) 218. The first control loop is for the first supply voltage (V_{SUPPLY1}), and the second control loop is for the second supply voltage (V_{SUPPLY2}).

The LDO regulator changes the control loops based on the selected supply voltage through the first switch (SW₁) 216 and the second switch (SW₂) 218. When the first supply voltage (V_{SUPPLY1}) is selected, the first switch (SW₁) 216 is closed, and the second switch (SW₂) 218 is open. This configuration activates the first control loop, which includes the first p-channel transistor (M_{P1}) 202 and the second p-channel transistor (M_{P2}) 204. The error amplifier 214 controls the conductivity of the second p-channel transistor (M_{P2}) 204 to regulate the output voltage (V_{OUT}).

On the other hand, when the second supply voltage (V_{SUPPLY2}) is selected, the second switch (SW₂) 218 is closed, and the first switch (SW₁) 216 is open. This configuration activates the second control loop, which includes the third P-channel transistor (M_{P3}) 206 and the fourth p-channel transistor (M_{P4}) 208. The error amplifier 214 controls the conductivity of the fourth p-channel transistor (M_{P4}) 208 to regulate the output voltage (V_{OUT}).

By eliminating the fifth p-channel transistor (M_{P5}) and using the second p-channel transistor (M_{P2}) 204 and the fourth p-channel transistor (M_{P4}) 208 as control transistors, the area of each transistor can be reduced to

$$\frac{2 \times W}{L}$$

compared to the regulator circuit 100. This reduction in transistor size results in an overall area increase of

$$\frac{8 \times W}{L}$$

compared to the single supply arrangement without multiple supplies.

The error amplifier 214 compares the feedback voltage (V_{FB}) from the voltage divider formed by the first resistor (R₁) 210 and the second resistor (R₂) 212 with a reference voltage (V_{REF}). The output of the error amplifier 214 is provided to the gates of the second p-channel transistor (M_{P2}) 204 and the fourth p-channel transistor (M_{P4}) 208 in the active control loop to regulate the output voltage (V_{OUT}).

The proposed solution in regulator circuit 200 effectively reduces the area overhead associated with the switching circuit in LDO regulators while maintaining the ability to switch between multiple supply voltages.

In the regulator circuit 200, the first p-channel transistor (M_{P1}) 202 and the third P-channel transistor (M_{P3}) 206 serve as protection transistors. These protection transistors are coupled in series with the second p-channel transistor (M_{P2}) 204 and the fourth p-channel transistor (M_{P4}) 208, respectively, and are controlled by the control circuit 220. The primary purpose of the protection transistors is to prevent reverse current flow and protect the LDO regulator from damage caused by voltage fluctuations or transient events.

When the first supply voltage (V_{SUPPLY1}) is selected, the first p-channel transistor (M_{P1}) 202 is turned on, allowing current to flow through the second p-channel transistor (M_{P2}) 204, which regulates the output voltage (V_{OUT}). Similarly, when the second supply voltage (V_{SUPPLY2}) is selected, the third P-channel transistor (M_{P3}) 206 is turned on, allowing current to flow through the fourth p-channel transistor (M_{P4}) 208, which regulates the output voltage (V_{OUT}). The protection transistors also help to isolate the control loops and prevent unintended interactions between the supply voltages.

The LDO regulator architecture presented in FIG. 2 offers an improvement over the baseline solution by reducing the number of transistors required for power supply switching. This architecture achieves a more compact design by eliminating the fifth p-channel transistor (M_{P5}) 110 and utilizing the existing transistors as control transistors. The dual control loop configuration, enabled by the switches, allows for efficient power supply switching while maintaining a stable output voltage (V_{OUT}). This approach provides a balance between area optimization and reliable power supply switching functionality.

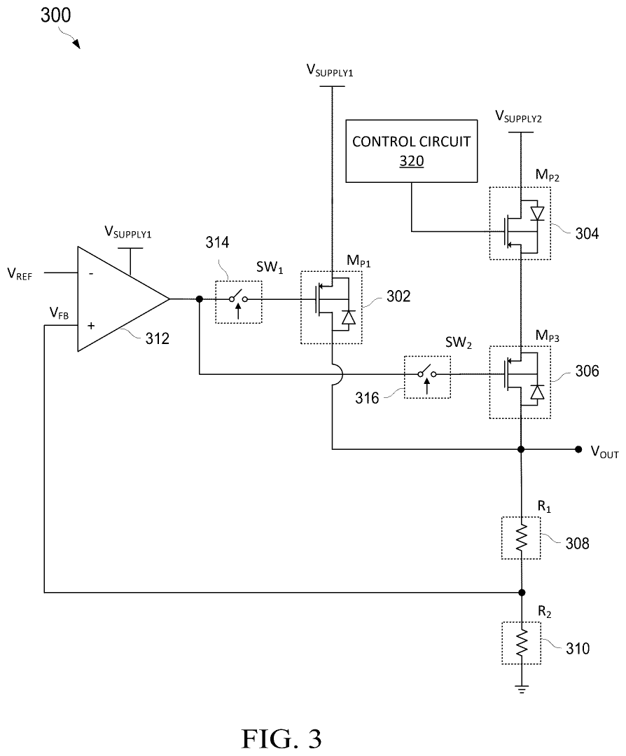

FIG. 3 illustrates a schematic of a regulator circuit 300, which can be used to change the supply in an LDO regulator. Regulator circuit 300 includes a first p-channel transistor (M_{P1}) 302, a second p-channel transistor (M_{P2}) 304, a third p-channel transistor (M_{P3}) 306, a first resistor (R₁) 308, a second resistor (R₂) 310, an error amplifier 312, a first switch (SW₁) 314, a second switch (SW₂) 316, and a control circuit 320, which may be arranged as shown. The gate terminal of the second p-channel transistor (M_{P2}) 304 is coupled to the control circuit 320, which controls the switching between the supplies. Regulator circuit 300 may include additional components not shown.

The proposed solution in regulator circuit 300 further optimizes the area compared to the regulator circuit 200 by removing the back-to-back switches in the first supply voltage loop. In this configuration, the first p-channel transistor (M_{P1}) 302 is directly coupled between the first supply voltage (V_{SUPPLY1}) and the output voltage (V_{OUT}), eliminating the need for a back-to-back switch.

The control circuit 320 generates the control signal for the second p-channel transistor (M_{P2}) 304, as well as the control signals for the first switch (SW₁) 314 and the second switch (SW₂) 316. The control circuit 320 monitors the availability and characteristics of the power supplies) and determines the appropriate switching sequence. It ensures that the LDO regulator seamlessly switches between the power supplies without causing disruptions or instability in the regulated output voltage (V_{OUT}). The control circuit 320 may incorporate additional features, such as voltage monitoring and comparators, to detect the presence and suitability of the power supplies for switching.

The error amplifier 312 is coupled to the gate of the first p-channel transistor (M_{P1}) 302 in the first control loop when the first switch (SW₁) 314 is closed and the second switch (SW₂) 316 is open. In this configuration, the error amplifier 312 controls the conductivity of the first p-channel transistor (M_{P1}) 302 to regulate the output voltage (V_{OUT}) based on the first supply voltage (V_{SUPPLY1}).

On the other hand, when the second supply voltage (V_{SUPPLY2}) is selected, the second switch (SW₂) 316 is closed, and the first switch (SW₁) 314 is open. This configuration activates the second control loop, which includes the second p-channel transistor (M_{P2}) 304 and the third p-channel transistor (M_{P3}) 306. The error amplifier 312 is coupled to the gate of the third p-channel transistor (M_{P3}) 306 in the second control loop, controlling its conductivity to regulate the output voltage (V_{OUT}) based on the second supply voltage (V_{SUPPLY2}).

By removing the back-to-back switches in the first supply voltage loop, the area of the first p-channel transistor (M_{P1}) 302 is reduced to W/L, whereas the area of each of the second p-channel transistor (M_{P2}) 304 and the third p-channel transistor (M_{P3}) 306 remains at

$$\frac{2 \times W}{L} .$$

This arrangement gives a total area of

$$\frac{5 \times W}{L}$$

compared to the single supply regulator, which is a further reduction from the

$$\frac{8 \times W}{L}$$

area of regulator circuit 200.

The drain-to-source voltage (V_{DS}) for each transistor in the first control loop, which includes only the first p-channel transistor (M_{P1}) 302, is equal to V_{DS}. In the second control loop, the drain-to-source voltage (V_{DS}) for each of the second p-channel transistor (M_{P2}) 304 and the third p-channel transistor (M_{P3}) 306 is V_{DS}/2. This results in an overall drain-to-source voltage (V_{DS}) equal to the V_{DS} in the first control loop, ensuring consistent voltage drop across the transistors in both control loops.

The error amplifier 312 compares the feedback voltage (V_{FB}) from the voltage divider formed by the first resistor (R₁) 308 and the second resistor (R₂) 310 with a reference voltage (V_{REF}). The output of the error amplifier 312 is provided to the gate of the first p-channel transistor (M_{P1}) 302 in the first control loop when the first switch (SW₁) 314 is closed and to the gate of the third p-channel transistor (M_{P3}) 306 in the second control loop when the second switch (SW₂) 316 is closed, regulating the output voltage (V_{OUT}) based on the selected supply voltage.

The proposed solution in regulator circuit 300 further reduces the area overhead associated with the switching circuit in LDO regulators while maintaining the ability to switch between multiple supply voltages. This design assumes that the first supply voltage (V_{SUPPLY1}) is always greater than the second supply voltage (V_{SUPPLY2}), allowing for the removal of the back-to-back switches in the first supply voltage loop.

In the regulator circuit 300, the second p-channel transistor (M_{P2}) 304 serves as a protection transistor. This protection transistor is coupled in series with the third p-channel transistor (M_{P3}) 306 between the second supply voltage (V_{SUPPLY2}) and the output voltage (V_{OUT}). The primary purpose of the protection transistor is to prevent reverse current flow and protect the LDO regulator from damage caused by voltage fluctuations or transient events when the second supply voltage (V_{SUPPLY2}) is selected.

When the second switch (SW₂) 316 is closed, and the first switch (SW₁) 314 is open, the second p-channel transistor (M_{P2}) 304 is turned on, allowing current to flow through the third p-channel transistor (M_{P3}) 306, which regulates the output voltage (V_{OUT}) based on the second supply voltage (V_{SUPPLY2}). The protection transistor also helps to isolate the second control loop from the first control loop, preventing unintended interactions between the supply voltages. In the first control loop, the first p-channel transistor (M_{P1}) 302 is directly coupled between the first supply voltage (V_{SUPPLY1}) and the output voltage (V_{OUT}), eliminating the need for a protection transistor in this path.

The LDO regulator architecture presented in FIG. 3 further optimizes the area compared to the previous embodiments by removing the back-to-back switches in the first supply voltage loop. This design assumes that the first supply voltage (V_{SUPPLY1}) is always greater than the second supply voltage (V_{SUPPLY2}), allowing for the direct connection of the first p-channel transistor (M_{P1}) 302 between the first supply voltage (V_{SUPPLY1}) and the output voltage (V_{OUT}). This simplification reduces the overall area of the LDO regulator while still maintaining the ability to switch between the power supplies.

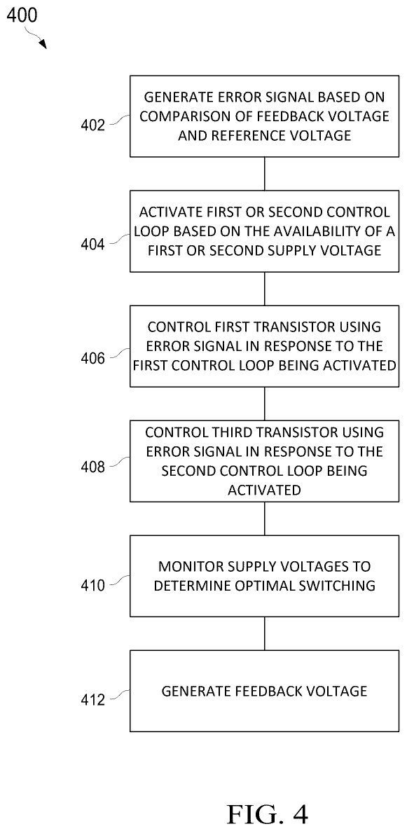

FIG. 4 illustrates a flowchart of an embodiment method 400 for operating an LDO regulator. It is noted that all steps outlined in the flowchart of the method are not necessarily required and can be optional. Further, changes to the arrangement of the steps, removal of one or more steps and path connections, and addition of steps and path connections are similarly contemplated.

At step 402, a feedback voltage is compared with a reference voltage to generate an error signal. This comparison can be performed by an error amplifier within the LDO regulator.

At step 404, the method selectively activates either a first control loop or a second control loop based on the availability of a first supply voltage and a second supply voltage. The first control loop comprises a first transistor coupled between the first supply voltage and the output node of the LDO regulator, while the second control loop comprises a second transistor and a third transistor coupled in series between the second supply voltage and the output node of the LDO regulator.

At step 406, in response to the first control loop being activated, the first transistor is controlled using the error signal generated in step 402. This is achieved by closing a first switch coupled between the output of the error amplifier and the gate of the first transistor in response to the first supply voltage being available.

At step 408, in response to the second control loop being activated, the third transistor is controlled using the error signal generated in step 402. This is achieved by closing a second switch coupled between the output of the error amplifier and the gate of the third transistor in response to the second supply voltage being available.

At step 410, the availability of the first supply voltage and the second supply voltage is monitored to determine an optimal switching sequence between the first control loop and the second control loop. This monitoring can be performed by a control circuit within the LDO regulator.

At step 412, the feedback voltage is generated using a voltage divider coupled to the output node of the LDO regulator. This feedback voltage is used in step 402 for comparison with the reference voltage to generate the error signal.

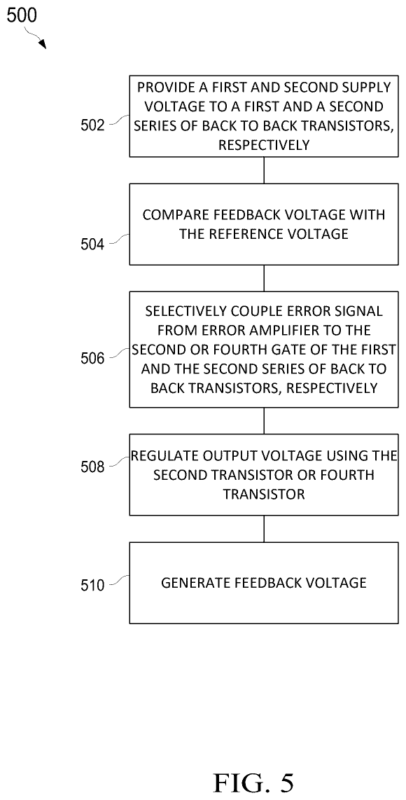

FIG. 5 illustrates a flowchart of an embodiment method 500 for operating an LDO regulator. It is noted that all steps outlined in the flowchart of the method are not necessarily required and can be optional. Further, changes to the arrangement of the steps, removal of one or more steps and path connections, and addition of steps and path connections are similarly contemplated.

At step 502, a first supply voltage is provided to a first transistor and a second transistor coupled in series between the first supply voltage and the output node of the LDO regulator, while a second supply voltage is provided to a third transistor and a fourth transistor coupled in series between the second supply voltage and the output node of the LDO regulator.

At step 504, a feedback voltage derived from the output voltage of the LDO regulator is compared with a reference voltage using an error amplifier to generate an error signal.

At step 506, the error signal is selectively coupled to either the gate of the second transistor or the gate of the fourth transistor based on the availability of the first supply voltage and the second supply voltage. This selective coupling is achieved by controlling a first switch coupled between the output of the error amplifier and the gate of the second transistor, and a second switch coupled between the output of the error amplifier and the gate of the fourth transistor. A control circuit monitors the availability of the first and second supply voltages and controls the switches accordingly.

At step 508, the output voltage of the LDO regulator is regulated using the second transistor when the error signal is coupled to the gate of the second transistor, or using the fourth transistor when the error signal is coupled to the gate of the fourth transistor. The conductivity of the selected transistor is controlled by the error signal to maintain a stable output voltage.

Step 510 involves generating the feedback voltage used for comparison with the reference voltage using a voltage divider coupled to the output node of the LDO regulator. In embodiments, additional design considerations are included, such as providing the first supply voltage from a battery and the second supply voltage from a switching converter, using p-channel transistors for the transistors, sizing the transistors to achieve a total area of

$$\frac{8 \times W}{L}$$

for the LDO regulator, and ensuring a consistent voltage drop across the second and fourth transistors when regulating the output voltage.

A first aspect relates to a low drop-out (LDO) regulator, comprising an error amplifier configured to compare a feedback voltage with a reference voltage and generate an error signal; a first control loop comprising a first transistor coupled between a first supply voltage and an output node of the LDO regulator; a second control loop comprising a second transistor and a third transistor coupled in series between a second supply voltage and the output node of the LDO regulator; a first switch coupled between an output of the error amplifier and a gate of the first transistor; a second switch coupled between the output of the error amplifier and a gate of the third transistor; and a control circuit configured to control the first switch and the second switch to selectively activate the first control loop or the second control loop based on the availability of the first supply voltage and the second supply voltage.

In a first implementation form of the LDO regulator, according to the first aspect as such, the control circuit is configured to close the first switch and open the second switch to activate the first control loop when the first supply voltage is available; and open the first switch and close the second switch to activate the second control loop when the second supply voltage is available.

In a second implementation form of the LDO regulator, according to the first aspect as such or any preceding implementation form of the first aspect, the first transistor is directly coupled between the first supply voltage and the output node of the LDO regulator, and the second transistor and the third transistor are coupled in series between the second supply voltage and the output node of the LDO regulator.

In a third implementation form of the LDO regulator, according to the first aspect as such or any preceding implementation form of the first aspect, the first transistor, the second transistor, and the third transistor are p-channel transistors.

In a fourth implementation form of the LDO regulator, according to the first aspect as such or any preceding implementation form of the first aspect, the control circuit is configured to monitor the availability of the first supply voltage and the second supply voltage to determine an optimal switching sequence between the first control loop and the second control loop.

In a fifth implementation form of the LDO regulator, according to the first aspect as such or any preceding implementation form of the first aspect, the control circuit comprises hysteresis and debounce mechanisms to prevent unwanted oscillations and ensure stable operation during switching between the first control loop and the second control loop.

In a sixth implementation form of the LDO regulator, according to the first aspect as such or any preceding implementation form of the first aspect, the first supply voltage is provided by a battery, and the second supply voltage is provided by a switching converter.

In a seventh implementation form of the LDO regulator, according to the first aspect as such or any preceding implementation form of the first aspect, the feedback voltage is provided by a voltage divider coupled to the output node of the LDO regulator.

In an eighth implementation form of the LDO regulator, according to the first aspect as such or any preceding implementation form of the first aspect, an area of the first transistor is W/L, and an area of each of the second transistor and the third transistor is 2 W/L.

In a ninth implementation form of the LDO regulator, according to the first aspect as such or any preceding implementation form of the first aspect, a drain-to-source voltage of the first transistor in the first control loop is equal to a sum of drain-to-source voltages of the second transistor and the third transistor in the second control loop.

A second aspect relates to a method for regulating an output voltage of a low drop-out (LDO) regulator, the method comprising comparing a feedback voltage with a reference voltage to generate an error signal; selectively activating a first control loop or a second control loop based on the availability of a first supply voltage and a second supply voltage, wherein the first control loop comprises a first transistor coupled between the first supply voltage and the output node of the LDO regulator, and the second control loop comprises a second transistor and a third transistor coupled in series between the second supply voltage and the output node of the LDO regulator; controlling the first transistor using the error signal when the first control loop is active; and controlling the third transistor using the error signal when the second control loop is active.

In a first implementation form of the method, according to the second aspect as such, the method further comprising closing a first switch coupled between an output of an error amplifier and a gate of the first transistor to activate the first control loop; and closing a second switch coupled between the output of the error amplifier and a gate of the third transistor to activate the second control loop.

In a second implementation form of the method, according to the second aspect as such or any preceding implementation form of the second aspect, the method further comprising closing the first switch and opening the second switch to activate the first control loop in response to the first supply voltage being available; and opening the first switch and closing the second switch to activate the second control loop in response to the second supply voltage being available.

In a third implementation form of the method, according to the second aspect as such or any preceding implementation form of the second aspect, the method further comprising directly coupling the first transistor between the first supply voltage and the output node of the LDO regulator, and coupling the second transistor and the third transistor in series between the second supply voltage and the output node of the LDO regulator.

In a fourth implementation form of the method, according to the second aspect as such or any preceding implementation form of the second aspect, the method further comprising monitoring the availability of the first supply voltage and the second supply voltage to determine an optimal switching sequence between the first control loop and the second control loop.

In a fifth implementation form of the method, according to the second aspect as such or any preceding implementation form of the second aspect, the method further comprising providing the first supply voltage from a battery and the second supply voltage from a switching converter.

In a sixth implementation form of the method, according to the second aspect as such or any preceding implementation form of the second aspect, the method further comprising generating the feedback voltage using a voltage divider coupled to the output node of the LDO regulator.

A third aspect relates to a low drop-out (LDO) regulator, comprising an error amplifier configured to compare a feedback voltage with a reference voltage and generate an error signal; a first transistor coupled between a first supply voltage and an output node of the LDO regulator; a second transistor coupled between the first transistor and the output node of the LDO regulator; a third transistor coupled between a second supply voltage and the output node of the LDO regulator; a fourth transistor coupled between the third transistor and the output node of the LDO regulator; a first switch coupled between an output of the error amplifier and a gate of the second transistor; a second switch coupled between the output of the error amplifier and a gate of the fourth transistor; and a control circuit configured to control gate terminals of the first transistor and the third transistor, and control the first switch and the second switch to selectively activate a first control loop comprising the first transistor and the second transistor or a second control loop comprising the third transistor and the fourth transistor based on the availability of the first supply voltage and the second supply voltage.

In a first implementation form of the LDO regulator, according to the third aspect as such, the control circuit is configured to close the first switch and open the second switch to activate the first control loop when the first supply voltage is available, wherein the error signal controls the second transistor to regulate the output node of the LDO regulator; and open the first switch and close the second switch to activate the second control loop when the second supply voltage is available, wherein the error signal controls the fourth transistor to regulate the output node of the LDO regulator.

In a second implementation form of the LDO regulator, according to the third aspect as such or any preceding implementation form of the third aspect, an area of each of the first transistor and the third transistor is W/L, and an area of each of the second transistor and the fourth transistor is 2 W/L.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A low drop-out (LDO) regulator, comprising:
an error amplifier configured to compare a feedback voltage with a reference voltage and generate an error signal;
a first control loop comprising a first transistor coupled between a first supply voltage and an output node of the LDO regulator;
a second control loop comprising a second transistor and a third transistor coupled in series between a second supply voltage and the output node of the LDO regulator;
a first switch coupled between an output of the error amplifier and a gate of the first transistor;
a second switch coupled between the output of the error amplifier and a gate of the third transistor; and
a control circuit configured to control the first switch and the second switch to selectively activate the first control loop or the second control loop based on the availability of the first supply voltage and the second supply voltage.

2. The LDO regulator of claim 1, wherein the control circuit is configured to:
close the first switch and open the second switch to activate the first control loop when the first supply voltage is available; and
open the first switch and close the second switch to activate the second control loop when the second supply voltage is available.

3. The LDO regulator of claim 1, wherein the first transistor is directly coupled between the first supply voltage and the output node of the LDO regulator, and the second transistor and the third transistor are coupled in series between the second supply voltage and the output node of the LDO regulator.

4. The LDO regulator of claim 1, wherein the first transistor, the second transistor, and the third transistor are p-channel transistors.

5. The LDO regulator of claim 1, wherein the control circuit is configured to monitor the availability of the first supply voltage and the second supply voltage to determine an optimal switching sequence between the first control loop and the second control loop.

6. The LDO regulator of claim 1, wherein the control circuit comprises hysteresis and debounce mechanisms to prevent unwanted oscillations and ensure stable operation during switching between the first control loop and the second control loop.

7. The LDO regulator of claim 1, wherein the first supply voltage is provided by a battery, and the second supply voltage is provided by a switching converter.

8. The LDO regulator of claim 1, wherein the feedback voltage is provided by a voltage divider coupled to the output node of the LDO regulator.

9. The LDO regulator of claim 1, wherein an area of the first transistor is W/L, and an area of each of the second transistor and the third transistor is 2 W/L.

10. The LDO regulator of claim 1, wherein a drain-to-source voltage of the first transistor in the first control loop is equal to a sum of drain-to-source voltages of the second transistor and the third transistor in the second control loop.

11. A method for regulating an output voltage of a low drop-out (LDO) regulator, the method comprising:
comparing a feedback voltage with a reference voltage to generate an error signal;
selectively activating a first control loop or a second control loop based on the availability of a first supply voltage and a second supply voltage, wherein the first control loop comprises a first transistor coupled between the first supply voltage and the output node of the LDO regulator, and the second control loop comprises a second transistor and a third transistor coupled in series between the second supply voltage and the output node of the LDO regulator;
controlling the first transistor using the error signal when the first control loop is active; and
controlling the third transistor using the error signal when the second control loop is active.

12. The method of claim 11, further comprising:
closing a first switch coupled between an output of an error amplifier and a gate of the first transistor to activate the first control loop; and
closing a second switch coupled between the output of the error amplifier and a gate of the third transistor to activate the second control loop.

13. The method of claim 12, further comprising:
closing the first switch and opening the second switch to activate the first control loop in response to the first supply voltage being available; and
opening the first switch and closing the second switch to activate the second control loop in response to the second supply voltage being available.

14. The method of claim 11, further comprising directly coupling the first transistor between the first supply voltage and the output node of the LDO regulator, and coupling the second transistor and the third transistor in series between the second supply voltage and the output node of the LDO regulator.

15. The method of claim 11, further comprising monitoring the availability of the first supply voltage and the second supply voltage to determine an optimal switching sequence between the first control loop and the second control loop.

16. The method of claim 11, further comprising providing the first supply voltage from a battery and the second supply voltage from a switching converter.

17. The method of claim 11, further comprising generating the feedback voltage using a voltage divider coupled to the output node of the LDO regulator.

18. A low drop-out (LDO) regulator, comprising:
an error amplifier configured to compare a feedback voltage with a reference voltage and generate an error signal;
a first transistor coupled between a first supply voltage and an output node of the LDO regulator;
a second transistor coupled between the first transistor and the output node of the LDO regulator;
a third transistor coupled between a second supply voltage and the output node of the LDO regulator;
a fourth transistor coupled between the third transistor and the output node of the LDO regulator;
a first switch coupled between an output of the error amplifier and a gate of the second transistor;
a second switch coupled between the output of the error amplifier and a gate of the fourth transistor; and
a control circuit configured to:
control gate terminals of the first transistor and the third transistor, and
control the first switch and the second switch to selectively activate a first control loop comprising the first transistor and the second transistor or a second control loop comprising the third transistor and the fourth transistor based on the availability of the first supply voltage and the second supply voltage.

19. The LDO regulator of claim 18, wherein the control circuit is configured to:
close the first switch and open the second switch to activate the first control loop when the first supply voltage is available, wherein the error signal controls the second transistor to regulate the output node of the LDO regulator; and
open the first switch and close the second switch to activate the second control loop when the second supply voltage is available, wherein the error signal controls the fourth transistor to regulate the output node of the LDO regulator.

20. The LDO regulator of claim 18, wherein an area of each of the first transistor and the third transistor is W/L, and an area of each of the second transistor and the fourth transistor is 2 W/L.
